(19) United States
(12) Patent Application Publication
(10) Pub. No.: US 2009/0189366 A1
(43) Pub. Date: Jul. 30, 2009

(54) OUTER TUBE FOR FRONT FORK

(75) Inventors: Tomoya Toda, Fukuroi-shi (JP); Makoto Hayashi, Kyoto-shi (JP); Masao Hirukawa, Kyoto-shi (JP)

Correspondence Address: BABCOCK IP, PLLC, P.O.BOX 488, BRIDGMAN, MI, 49106, US

(73) Assignee: SHOWA CORPORATION, Gyoda-shi (JP)

(21) Appl. No.: 12/336,462

(22) Filed: Dec. 16, 2008

(30) Foreign Application Priority Data
Jan. 30, 2008 (JP) 2008-019837

(51) Int. Cl. B62K 25/04

(52) U.S. Cl. 280/276

(57) ABSTRACT

An outer tube for a front fork having an FRP pipe body which is subjected to braiding processing using a braider, wherein the FRP pipe comprises a combination of braids interlacing with each other at interlacing angle ±θ° with respect to a pipe center axis, a value of an interlacing angle ±θ° of the braids during the braiding processing period is varied, and bending rigidity in a longitudinal direction of the FRP pipe is varied in along longitudinal extent.

### BACKGROUND OF THE INVENTION

1. Field of the Invention

The present invention relates to an outer tube for a front fork using a fiber reinforced plastics (FRP) pipe.

2. Description of the Related Art

In an inverted type front fork of a two-wheeled motor vehicle, an inner tube on the side of an axle is slidably inserted into an outer tube on the side of a vehicle body, and since a diameter of the outer tube is greater than that of the inner tube, rigidity of the outer tube is greater than that of the inner tube.

An outer tube described in Japanese Utility Model Application Laid-open No. 3-26845 (patent document 1) comprises a complex of a CFRP (carbon fiber reinforced plastic) layer and a light alloy layer, and is constituted such that a thickness of the CFRP layer on the side of a free end of the outer tube is thinner than that on the side of a vehicle body mounting portion. With this, rigidity of a portion of the outer tube near the vehicle body mounting portion is sufficiently enhanced, rigidity on the side of the free end of the outer tube into which an inner tube is inserted and supported is lowered so that the outer tube can easily bow, and following capability of a front fork with respect to variation in road surface is enhanced during running.

In the outer tube for the front fork described in the patent document 1, the thickness of the CFRP layer is varied in its longitudinal direction, and bending rigidity in the longitudinal direction can be varied in the longitudinal position. However, the thickness of the CFRP layer is adjusted by means of the number of laminated resin-impregnated fiber sheets (prepreg sheets) of the CFRP material, which is complicated and increases cost of manufacture.

### SUMMARY OF THE INVENTION

In an outer tube for a front fork using an FRP pipe, it is an object of the present invention to easily vary longitudinal direction bending rigidity along the longitudinal extent of the FRP pipe.

The present invention relates to an outer tube for a front fork having an FRP pipe body that is subjected to braiding processing using a braider. The FRP pipe comprises a combination of braids interlacing with each other at interlacing angle ±θ° with respect to a pipe center axis. The interlacing angle ±θ° of the braids is varied during the braiding processing period. Thus, the longitudinal bending rigidity is varied along the longitudinal extent of the FRP pipe.

The present invention relates to an inverted type front fork in which an inner tube on the side of an axle is slidably inserted into an outer tube on the side of a vehicle body. The outer tube includes an FRP pipe body that is subjected to braiding processing using a braider. The FRP pipe comprises a combination of braids interlacing with each other at the interlacing angle ±θ° with respect to the pipe center axis, a value of the interlacing angle ±θ° of the braids is varied during the braiding processing period. Thus, the longitudinal bending rigidity is varied along the longitudinal extent of the FRP pipe.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIGS. 1A and 1B show a front fork, wherein FIG. 1A is a schematic side view and FIG. 1B is a schematic front view;

FIG. 2 is a sectional view showing an outer tube;

FIG. 3 is a schematic perspective view showing a braided cord body of an FRP pipe; and

FIGS. 4A to 4C show the braided cord body of the FRP pipe, wherein FIG. 4A is a schematic plan view of a high rigid body, FIG. 4B is a schematic plan view of an intermediate rigid body, and FIG. 4C is a schematic plan view of a low rigid body.

### DESCRIPTION OF THE PREFERRED EMBODIMENTS

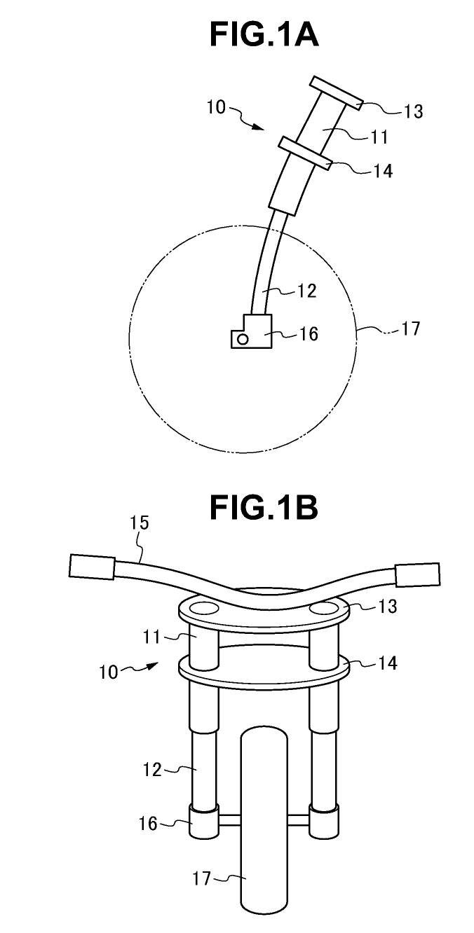

FIGS. 1A and 1B show an inverted type front fork 10. An axle-side inner tube 12 is slidably inserted into a vehicle body-side outer tube 11, and a damping mechanism is embedded. Left and right outer tubes 11 are connected to a vehicle body mounting upper bracket 13 and a vehicle body mounting lower bracket 14. A handle rotation shaft (not shown) connects the vehicle body mounting upper bracket 13 and the vehicle body mounting lower bracket 14 with each other. The handle rotation shaft is pivotally supported by a head pipe of a vehicle body frame. A handle bar 15 is fixed to the vehicle body mounting upper bracket 13. Axle brackets 16 are provided on lower ends of the left and right inner tubes 12. An axle of a wheel 17 is pivotally supported by the axle brackets 16.

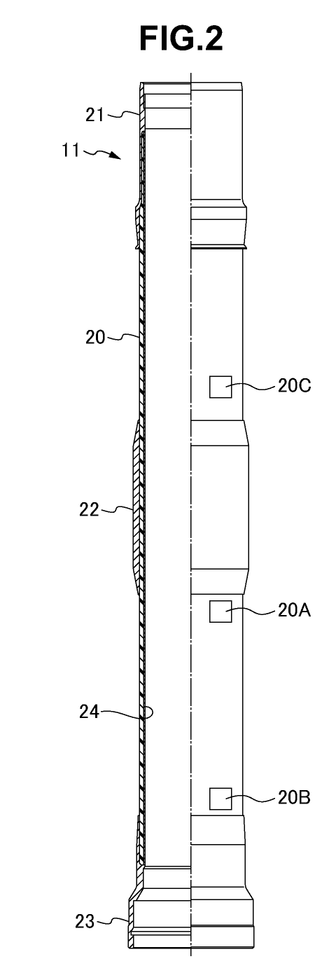

As shown in FIG. 2, the outer tube 11 has an FRP pipe body 20, an upper collar 21 is fitted to an upper end of the body 20, the vehicle body mounting upper bracket 13 is coupled to the upper collar 21, a lower collar 22 is fitted to an intermediate portion of the body 20, the vehicle body mounting lower bracket 14 is coupled to the lower collar 22, and a seal case 23 is fitted to a lower end of the body 20. The inner tube 12 is inserted into and supported by the seal case 23. The upper collar 21, the lower collar 22 and the seal case 23 may be, for example, constituted by metal such as aluminum alloy. A metal thin tube 24 made of aluminum alloy, iron, or the like, is fitted to an inner periphery of the body 20 to secure roundness of the body 20 and to enhance the sliding performance of the inner tube 12. In this invention, it is not absolutely necessary to have the metal thin tube 24. The metal thin tube 24 fitted to the body 20 is fitted to the inner peripheral steps of the upper and lower collars 21 and 22 and is prevented from coming out.

The inner tube 12 can be constituted by an FRP pipe or a metal pipe made of aluminum alloy, iron, or the like.

A structure of an outer tube 11 will be described in detail.

It is necessary that rigidity of the outer tube 11 near a vehicle body mounting portion supported by a vehicle body mounting lower bracket 14 (lower collar 22) is high, rigidity of a lower end (free end) of the outer tube 11 into which an inner tube 12 is inserted and supported is low to provide an enhanced following characteristic of the front fork 10 with respect to the variation in the road surface during running, and the lower end can easily bow. Therefore, the following structure is employed for an FRP pipe body 20 so that the bending rigidity can be easily varied in the longitudinal extent of the outer tube 11.

The FRP pipe 30 constituting the FRP pipe body 20 of the outer tube 11 comprises, for example, an FRP braiding braided cord body 30A which is braided (braided cord) using a braider, for example as described in Japanese Patent No. 3760994. A producing method of the FRP pipe 30 includes a braiding step for pre-setting a resin-impregnated thread (reinforced fiber) to a braider and weaving the braided cord body 30 by braiding, and a wrapping step for continuously wrapping a heat-shrinkable tape around the braided cord body 30A.

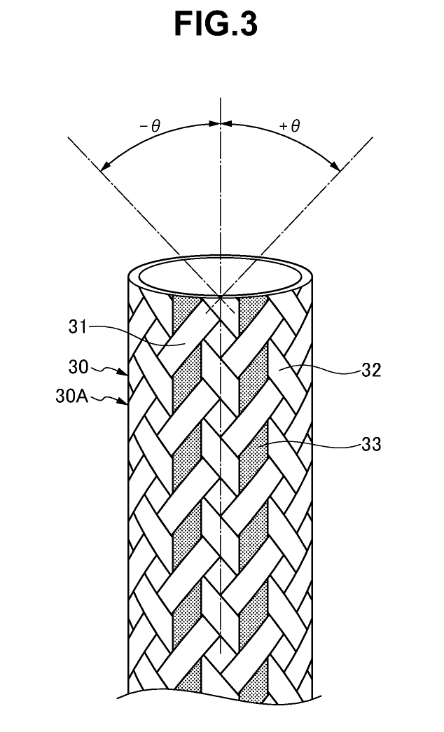

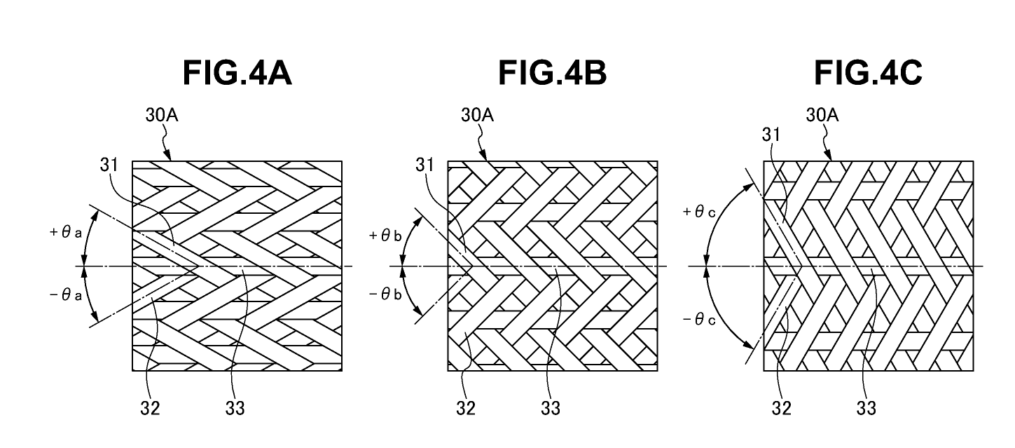

(1) Braiding Steps (FIGS. 3 and 4A to 4C)

In order to weave the FRP braiding braided cord body 30A which becomes the FRP pipe 30 with the braider, as shown in FIG. 3, braids 31 and 32 which are interlaced with each other at the interlacing angle ±θ° with respect to the pipe center axis, and a warp fiber 33 having an angle 0° with respect to the pipe center axis are combined around a mandrel. This processing is called braiding processing. With this braiding processing, one braided layer is constituted. The braided cord body 30A comprises at least one braided layer, and usually, a plurality of braided layers are laminated and composed.

In the braided cord body 30A of the present embodiment, a value of the interlacing angle ±θ° of the braids 31 and 32 during the above braiding processing period around a mandrel is continuously varied to any of θa, θb, and θc shown in FIGS. 4A, 4B and 4C along the longitudinal direction of the braided cord body 30A. The bending rigidity of the braided cord body 30A woven in the longitudinal direction with θa in FIG. 4A is high, the bending rigidity of the braided cord body 30A woven in the longitudinal direction with θb in FIG. 4B is medium, and the bending rigidity of the braided cord body 30A woven in the longitudinal direction with θc in FIG. 4C is low. By continuously varying the interlacing angle ±θ° of the braids 31 and 32 constituting the braided cord body 30A along the longitudinal direction of the braided cord body 30A, the bending rigidity in the longitudinal direction of the braided cord body 30A and of the FRP pipe 30 can arbitrarily be varied in the longitudinal position.

Threads of the braids 31 and 32 and the warp fiber 33 constituting the FRP pipe 30 (braided cord body 30A) are resin-impregnated threads. The kinds of the threads that may be applied are not limited. For example, carbon fiber (CF), glass fiber (GF), aramid fiber (AF), other high polymer fiber, metal thread and the like may be used. Resins are not limited to epoxy-based resin, imide-based resin and others, thermoplastic resin, and thermosetting resin, and any resin can be used.

(2) Wrapping Steps

By carrying out the above-described braiding steps (1), the braided cord body 30A is woven and in this state, the heat-shrinkable tape is continuously wound around the braided cord body 30A, thereby obtaining the FRP pipe 30. With this wrapping, resin is appropriately blown, appropriate resin content can be obtained and with this, mechanical characteristics of the material itself are enhanced.

(3) Producing Steps of Outer Tube

The above-described (2) FRP pipe 30 is defined as the FRP pipe body 20. The upper collar 21, the lower collar 22, the seal case 23 and the metal thin tube 24 are assembled to the body 20 and this is defined as the outer tube 11.

As shown in FIG. 2, the braided cord body 30A constituting a vehicle body mounting portion 20A of the FRP pipe body 20 (FRP pipe 30) constituting the outer tube 11 near the vehicle body mounting portion 20A supported by the vehicle body mounting lower bracket 14 (lower collar 22) comprises the high rigid body having the interlacing angle of the braids 31 and 32 of θa in FIG. 4A. The braided cord body 30A constituting the lower end (free end) 20B into which the inner tube 12 is inserted and supported comprises a low rigid body having the interlacing angle of the braids 31 and 32 of θc in FIG. 4C. The braided cord body 30A constituting the intermediate portion 20C sandwiched and supported between the vehicle body mounting upper bracket 13 (upper collar 21) and the vehicle body mounting lower bracket 14 (lower collar 22) has appropriate rigid body suitable for vehicle type, required steering stability, and the like, for example, medium rigid body having θb in FIG. 4B or low rigid body having θc in FIG. 4C, the interlacing angle of the braids 31 and 32.

According to the present embodiment, the following effects can be exhibited.

(a) The FRP pipe 30 constituting the outer tube 11 for the front fork comprises a combination of the braids 31 and 32 which interlace with each other with the interlacing angle ±θ° with respect to the pipe center axis, the value of the interlacing angle ±θ° of the braids 31 and 32 during the braiding processing period is varied, and the bending rigidity of the FRP pipe 30 in the longitudinal direction is arbitrarily varied in the longitudinal position. The bending rigidity of the outer tube 11 in the longitudinal direction can be cost effectively varied along the longitudinal extent by varying the value of the interlacing angle ±θ° of the braids 31 and 32 during the braiding processing period.

(b) In the inverted type front fork 10, the outer tube 11 of the above-described (a) can be used. With this, the rigidity of the outer tube 11 near the vehicle body mounting portion can sufficiently be increased, the rigidity of the lower end (free end) of the outer tube 11 into which the inner tube 12 is inserted and supported is lowered so that the outer tube 11 can easily bow, and the following capability of the front fork 10 with respect to variation in road surface during running can be enhanced.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention. For example, it is absolutely necessary that an FRP pipe 30 (braided cord body 30A) of the present invention uses braids 31 and 32, but it is not absolutely necessary that the FRP pipe 30 use a warp fiber 33.

The outer tube of the present invention can be configured in such a manner that a high rigidity portion or a low rigidity portion is obtained in specific portion(s) along the longitudinal extent.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. An outer tube for a front fork having an FRP pipe body which is subjected to braiding processing using a braider:
wherein the FRP pipe is comprised by combination of a plurality of braids interlacing with each other at an interlacing angle ±θ° with respect to a pipe center axis, a value of the interlacing angle ±θ° is varied during the braiding processing period, and whereby a bending rigidity in a longitudinal direction of the FRP pipe is varied along a longitudinal extent of the FRP pipe.

2. The outer tube for the front fork according to claim 1, wherein a braid body of the FRP pipe is a combination of braids interlacing with each other at interlacing angle ±θ° with respect to the pipe center axis, and a warp fiber having an angle of 0° with respect to the pipe center axis.

3. The outer tube for the front fork according to claim 1, wherein bending rigidity of the FRP pipe in the longitudinal direction is increased near a vehicle body mounting portion and is reduced at a lower end into which an inner tube is inserted and supported by varying the value of the interlacing angle ±θ° of the braid.

4. The outer tube for the front fork according to claim 2, wherein bending rigidity of the FRP pipe in the longitudinal direction is increased near a vehicle body mounting portion and is reduced at a lower end into which an inner tube is inserted and supported by varying the value of the interlacing angle ±θ° of the braid.

5. An inverted type front fork in which an inner tube on the side of an axle is slidably inserted into an outer tube on the side of a vehicle body, comprising:
an FRP pipe of the outer tube which is subjected to a braiding processing using a braider,
the FRP pipe comprises a combination of a plurality of braids interlacing with each other at the interlacing angle ±θ° with respect to the pipe center axis, a value of the interlacing angle ±θ° of the braids along a longitudinal extent of the FRP pipe is varied during the braiding processing, and the bending rigidity in the longitudinal extent of the FRP pipe is varied.

6. The inverted type front fork according to claim 5, wherein a braid body of the FRP pipe is a combination of braids interlacing with each other at interlacing angle ±θ° with respect to the pipe center axis, and a warp having an angle of 0° with respect to the pipe center axis.

7. The inverted type front fork according to claim 5, wherein bending rigidity of the FRP pipe in the longitudinal direction is increased near a vehicle body mounting portion and is reduced at a lower end into which an inner tube is inserted and supported by varying the value of the interlacing angle ±θ° of the braid.

8. The inverted type front fork according to claim 6, wherein bending rigidity of the FRP pipe in the longitudinal direction is increased near a vehicle body mounting portion and is reduced at a lower end into which an inner tube is inserted and supported by varying the value of the interlacing angle ±θ° of the braid.
